(19) United States
(12) Patent Application Publication
(10) Pub. No.: US 2020/0123052 A1
(43) Pub. Date: Apr. 23, 2020

(54) ENHANCED OPTICAL FIBERS FOR LOW TEMPERATURE SENSING

(71) Applicant: North Carolina State University, Raleigh, NC (US)

(72) Inventors: JUSTIN SCHWARTZ, Raleigh, NC (US); FEDERICO SCURTI, Raleigh, NC (US)

(21) Appl. No.: 16/067,938

(22) PCT Filed: Jan. 6, 2017
(86) PCT No.: PCT/US2017/012424

§ 371 Date: Jul. 3, 2018

Related U.S. Application Data
(60) Provisional application No. 62/276,511, filed on Jan. 8, 2016.

(51) Int. Cl. C03C 25/1065; G02B 6/02; G01L 1/24; G01K 11/32; C03C 25/106; C03C 25/16; C03C 25/285

(52) U.S. Cl. CPC C03C 25/109; G02B 6/02395; G01L 1/246; C03C 25/285; C03C 25/1063; C03C 25/16; G01K 11/3206

(57) ABSTRACT

Various examples and systems are provided for enhancing optical fibers for sensing temperature and/or strain at low temperatures (e.g., 1.8K to 77K or lower). An enhanced optical fiber for distributed sensing can comprise a core, a cladding surrounding the core, and a coating surrounding the cladding. A coefficient of thermal expansion (CTE) of the coating is greater than a CTE of silica and/or a Young's modulus (E) of the coating is greater than an E of silica.

### CROSS-REFERENCE TO RELATED APPLICATIONS

This application claims priority to, and the benefit of, co-pending U.S. provisional application entitled “ENHANCED OPTICAL FIBERS FOR LOW TEMPERATURE SENSING” having Ser. No. 62/276,511, filed on Jan. 8, 2016, which is hereby incorporated by reference in its entirety.

### BACKGROUND

Optical fiber sensors meet a number of sensing needs in many science and engineering fields. The interrogation techniques typically used for optical fiber sensors involve the transmission or reflection of light propagating in the fiber. At low temperatures (e.g., 1.8 Kelvin (K) to 77 K), the sensitivity of typical optical fiber sensors declines, thereby rendering the optical fiber sensor less effective.

### SUMMARY

Embodiments of the present disclosure are related to enhancing optical fibers for sensing of temperature and strain at low temperatures (e.g., 1.8 K to 77 K or lower).

In one embodiment, among others, an enhanced optical fiber for distributed sensing comprises a core, a cladding surrounding the core, and a coating surrounding the cladding. The cladding comprises a glass material, and at least one of (1) a coefficient of thermal expansion (CTE) of the coating is greater than a CTE of silica or (2) a Young's modulus (E) of the coating is greater than an E of silica.

In one or more aspects of these embodiments, the enhanced optical fiber can be configured to detect at least one of (1) a temperature change or (2) a strain within an operating temperature range of about 1.8 Kelvin (K) to about 77 K. In one or more aspects, the operating temperature range is about 1.8 K to about 30 K. In other aspects, the operating temperature range is about 1.8 K to about 5 K.

In one or more aspects of these embodiments, the coating can comprise comprises one or more layers. In one or more aspects, the coating can comprise at least one of: polyamide (PA), polyethylene (PE), high density polyethylene (HDPE), Polyvinyl chloride (PVC), chlorinated polyvinyl chloride (CPVC), carbon, acrylates, acrylonitrile butadiene styrene (ABS), an epoxy resin, a metal, or an oxide. In some embodiments, the metal can comprise at least one of: aluminum, aluminum alloy, copper, copper alloy, silver, silver alloy, gold, gold alloy, zinc, zinc alloy, lead, lead alloy, nickel, tin, indium, bismuth or their alloys, like indium-bismuth and bismuth-tin, for example. In some embodiments, the oxide can comprise at least one of titania, alumina, ceria or zirconia. In one or more aspects of these embodiments, the glass material comprises at least one of: silica, fluorite glass, or phosphate glass.

In one or more aspects of these embodiments, a diameter of the core is about 4 to about 8 μm. In one or more aspects of these embodiments, the diameter of the cladding is about 30 to about 125 μm. In some aspects, the enhanced optical fiber can comprise an intermediate layer situated between the cladding and the coating. In some aspects, the enhanced optical fiber is interrogated via at least one of Raleigh backscattering or Bragg gratings.

In another embodiment, among others, a method for enhancing an optical fiber for distributed sensing comprises inserting the optical fiber into an orifice at a first end of a coating element and moving the optical fiber through the coating material contained within the coating element to a second end of the coating element at a predefined speed. The coating element contains a coating material disposed within the coating element and the coating material is in a liquid form. The coating material comprises at least one: a coefficient of thermal expansion (CTE) that is greater than a CTE of silica or a Young's modulus (E) that is greater than an E of silica. The coating material bonds with an outer surface of the optical fiber as the optical fiber moves from the first end to the second end.

In one or more aspects of these embodiments, the predefined speed is based at least in part on at least one of a melting point of the coating material, a size of the orifice, a temperature of the coating material in the liquid form, or a temperature of the fiber upon contact with the coating material. In one or more aspects of the embodiments, a temperature of the fiber is lower than a melting point temperature of the coating material. In one or more aspects of the embodiments, the method further comprises cooling the optical fiber prior to inserting the optical fiber into the coating mechanism. In one or more aspects of the embodiments, a size of the orifice is based at least in part on a coating thickness and a diameter of the optical fiber being coated. In one or more aspects of the embodiments, the method further comprises transferring the coating material from a reservoir to the coating element via a feeder element. In one or more aspects of these embodiments, the method further comprises controlling a liquid level of the coating material within the coating element, the liquid level being based at least in part on at least one of the predefined speed, a temperature of the fiber, a melting point temperature of the coating material, a size of the orifice, or a temperature of the coating material in the liquid form.

Other devices, systems, methods, features, and advantages of the present disclosure will be or become apparent to one with skill in the art upon examination of the following drawings and detailed description. It is intended that all such additional devices, systems, methods, features, and advantages be included within this description, be within the scope of the present disclosure, and be protected by the accompanying claims.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a drawing of an example of a typical single mode telecommunication grade optical fiber.

FIG. 2 illustrates an example of a graphical representation of a spectral shift produced by a fixed thermal perturbation as a function of temperature indicating the sensitivity of the typical optical fiber of FIG. 1 at that temperature.

FIG. 3 is a drawing of an example of an enhanced optical fiber capable of sensing at low temperatures according to various embodiments of the present disclosure.

FIG. 4 is an example of a graphical representation of experimental results on thermal sensitivity of optical fibers of FIG. 3 with different coating materials according to various embodiments of the present disclosure.

FIG. 5 is an example of a cross section of a metal-polymer composite coating for the optical fiber of FIG. 3 according to various embodiments of the present disclosure.

FIG. 6 is an example of a cross section of the optical fiber of FIG. 3 comprising a tin coating deposited on a silica cladding according to various embodiments of the present disclosure.

FIGS. 7, 8, 9, and 10 are examples of schematic representations of coating systems for enhancing an optical fiber according to various embodiments of the present disclosure.

FIGS. 10 and 11 are examples of schematic representations of a coating element of the coating system of FIGS. 7, 8, and 9 according to various embodiments of the present disclosure.

FIG. 12 is an example of a schematic representation of a coating system of FIG. 7 with a cooling stage according to various embodiments of the present disclosure.

### DETAILED DESCRIPTION

The present disclosure relates to enhancing optical fibers for sensing of temperature and strain at low temperatures (e.g., 1.8 K to 77 K or lower). To enhance the thermal sensitivity of Rayleigh backscattering interrogated or Bragg grating based optical fiber sensors, for example, the core of an optical fiber can be elongated upon temperature changes such that alterations of defects of the fiber can be captured by interrogation and a measured signal can be generated. Specifically, by coating an optical fiber with one or more materials having a high thermal coefficient of expansion (CTE) (i.e., greater than the CTE of silica) and/or a high Young's modulus (E) (i.e., greater than the E of silica), the core of the optical fiber can still be elongated and the defect pattern of the optical fibers can still be captured at low temperatures. Low temperatures as used herein can be defined as temperatures within the range of about 1.8 K to 77 K or lower.

Optical fibers can be used as sensors using interrogation techniques that are based upon either the transmission or reflection of light propagating in the fiber. An interrogation technique may comprise Rayleigh backscattering, Bragg gratings, and/or any other viable interrogation approach. In Bragg gratings, a small Bragg grating is inscribed at one or more locations along the length of a fiber. The spacing of the grating has a characteristic reflection, so changes in the Bragg reflection indicate changes in the spacing between the lines of the grating. As the line spacing changes with either strain or temperature, a simple, fast point-sensor results. For superconducting magnets, however, the Bragg grating approach suffers from being a point-sensor, and so the improvement in spatial resolution over conventional voltage taps is limited. While one can inscribe multiple gratings on a single fiber, the approach remains intrinsically limited to measurements at pre-determined locations.

Another optical interrogation technique relates to deriving the signal using Rayleigh backscattering. The fundamental principle of Rayleigh backscattering is similar to that of Bragg gratings except that rather than inscribing gratings at predetermined locations on the optical fiber, the light scattered from the naturally occurring defects within the fiber is interpreted through a “Rayleigh interrogator.” When the fiber length is changed via a change in strain or temperature, these defects are altered, thus altering the reflected signal. A Rayleigh backscattering interrogator thus compares a reference backscattered spectrum to each subsequent spectra, and the resulting “spectral shifts,” which are a function of location and time, translate into the time-varying strain or temperature distributions. Since the spatial resolution is only limited by the wavelength of the interrogating light and by limitations associated with data acquisition and processing speed, the Rayleigh scattering interrogated optical fiber is a true distributed sensor. While other types of interrogating techniques can be used with optical fiber sensing, Rayleigh scattering is a preferred embodiment in the present disclosure.

Rayleigh backscattering based fiber optic distributed sensing, for example, works very well as a quench detection system for high temperature superconductors (HTS) at an operating temperature of about 77 K. However, the operating temperature of high field superconducting magnets is between about 1.8 K to 30 K. In this temperature range using a typical single mode telecommunication grade optical fiber, the sensitivity of the Rayleigh backscattering based fiber optic decreases and can reach a point where the optical fiber becomes practically insensitive. The reasons for the dramatic drop in sensitivity rests in the very low thermal expansion coefficient of the typical optical fiber and of the coatings of the typical optical fiber at low temperatures.

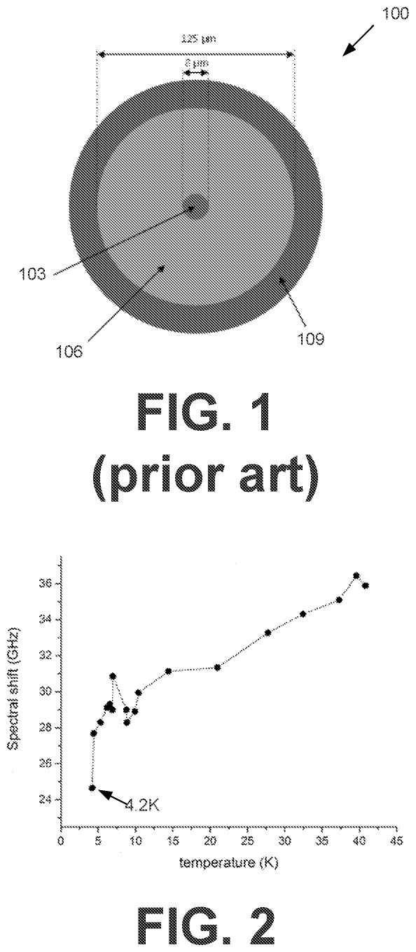

Turning now to FIG. 1, shown is a drawing of an example of a typical single mode telecommunication grade optical fiber 100. Typical optical fibers 100 can comprise a central core 103, a cladding 106, and a coating 109. A typical optical fiber 100 can be characterized by a relatively large cladding 106 having a diameter of approximately 125 μm or more. The core 103 and the cladding 106 can comprise almost pure silica (SiO₂) and doped silica, respectively, as well as other glasses, like fluoride and phosphate glasses. Appropriate selection of the core 103 and cladding 106 can ensure the total internal reflection of photons that travel along the fiber. Their composition is therefore constrained. Coatings of conventional optical fibers mainly aim at improving mechanical properties and protecting core and cladding from degradation during handling and installation. Typical coating materials comprise plastics and/or other types of coating. An additional layer (jacket) may surround the coating. This additional layer may comprise glass and/or other types of jacket material.

However, silica has a very low coefficient of thermal expansion (CTE) at low temperatures (e.g., about 1.8 K to 77 K or lower). As such, the fiber core 103 and the core-cladding interface are not elongated sufficiently upon a change in temperature of the entire fiber composite and, therefore, the defect pattern is not changed substantially. This is what reduces the sensitivity at low temperature when the fiber is used as a sensor, interrogated, for example, by Rayleigh scattering, Bragg gratings, and/or other type of interrogation technique.

The decrease in sensitivity of a typical optical fiber 100 at low temperature may be further explained by considering the measurement principle of a typical Rayleigh backscattering fiber optic sensor. For example, any optical fiber has a number of defects and density fluctuations. These defects and fluctuations are considered to be a static feature of the particular fiber. In addition, any given optical fiber 100 has its own pattern, which results in a given Rayleigh backscattering spectrum. As long as the temperature and strain are constant, the same fiber 100 will always give the same backscattered signal if injected with an identical beam of photons. However, upon a change in temperature or strain, the fiber is stretched (or shrunk), along with its defects. The change in the defect pattern gives rise to a different backscattered spectrum, where the wavelength of the backscattered photons would be shifted with respect to the backscattered spectrum of the unperturbed condition. A cross correlation of the two spectra relates to the change in temperature or strain experienced by the optical fiber. However, due to the low CTE of silicate and other glasses, the length of the fiber core 103 and the core-cladding interface of a typical fiber optic sensor do not change at low temperatures upon a change in temperature of the entire fiber composite and, therefore, the defect pattern is not changed substantially. Thus, the sensitivity at low temperatures when the fiber is used as a sensor decreases such that the benefits of the use of optical fibers as sensors are greatly diminished.

Moving on to FIG. 2, shown is a graphical representation illustration an example of a spectral shift produced by a fixed thermal perturbation as a function of temperature indicating the sensitivity of a typical optical fiber 100 at that temperature. The sensitivity of a typical optical fiber decreases roughly linearly as temperature decreases in the range of about 5 K to about 40 K, whereas the sensitivity is significantly reduced at temperatures below 5 K. In particular, note the data point in FIG. 2 marked 4.2 K, which is the average of multiple measurements repeated at 4.2 K. With an appropriate coating (offering high CTE and/or high E), the sensitivity versus temperature can be translated to higher sensitivities and the sensitivity drop below 5 K can be limited.

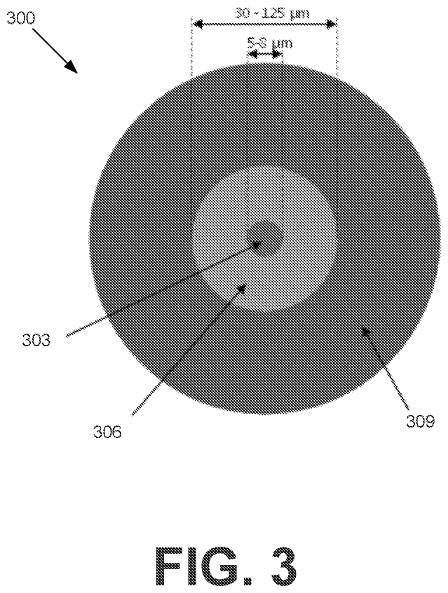

Turning now to FIG. 3, shown is an example of an enhanced optical fiber 300 according to various embodiments of the present disclosure. The enhanced optical fiber 300 comprises a core 303, a cladding 306, and a coating 309. Similar to the typical optical fiber 100 of FIG. 1, the core 303 and the cladding 306 of the enhanced optical fiber 300 can comprise substantially pure silica (SiO₂) and doped silica, respectively as well as other glasses (e.g., fluoride and phosphate glasses).

In some embodiments, the core 303 of the enhanced optical fiber can be about 5-8 μm. In some embodiments, the cladding 306 can be about 30-125 μm. When optical fibers are used for telecommunication purposes, the thickness of the cladding 106 is an important factor in preventing loss of data during transmissions. However, for temperature and strain sensing, the components that are needed in an optical fiber sensor are the fiber core and the core-cladding interface. A thick cladding offers no advantage. Having a thinner cladding 306 still allows the enhanced optical fibers 300 to be interrogated using various interrogation techniques, such as, for example, Rayleigh scattering, Bragg grating, and/or any other suitable interrogation techniques.

At low temperature, a thinner cladding 306 has less material to keep the fiber core 303 from elongating (or contracting) in response to temperature changes applied to the overall composite material (core 303, cladding 306, and coatings 309). Since the cladding material (e.g., silica) can result in a decrease in sensitivity at low temperatures, the size of the cladding thickness can be reduced and/or be partially replaced with a coating 309 that exhibits a higher coefficient of thermal expansion at low temperature than silica (SiO₂) or other glasses.

The coating 309 of the enhanced optical fiber 300 comprises one or more materials having a high CTE (i.e., greater than the CTE silica) and/or high Young's modulus (i.e., greater than the E of silica). For example, the coating may comprise polyamide (PA), polyethylene (PE), high density polyethylene (HDPE), Polyvinyl chloride (PVC), chlorinated polyvinyl chloride (CPVC), carbon, acrylates, acrylonitrile butadiene styrene (ABS), epoxy resins (both unfilled and filled, e.g., carbon epoxy), metals (e.g., aluminum, copper, silver, gold, zinc, lead, nickel, indium, bismuth, tin, and their alloys), oxides (e.g., titania, alumina and zirconia) and/or other type of material or combination thereof having a high CTE and high Young's modulus. It should be noted that silica has a nearly zero CTE (0-0.5×10⁻⁶ K ⁻¹) at 100 K and below, whereas metals can retain up to 25×10⁻⁶ K ⁻¹ at 100 K and polymers can still have CTEs of the order of 50×10⁻⁶ K at 100 K. In addition, the Young's modulus of silica at room temperature is about 70 gigapascals (GPa). Generally the Young's modulus does not strongly depend on temperature. However, the E of epoxy is about 2 GPa at 300 K and nearly doubles at 200 K. Room temperature modulus of elasticity for metals and metal alloys ranges between 30 GPa for lead-tin solder to 105 GPa for Zinc, whereas ceramic materials can have Young's moduli as high as aluminum oxide's 380 GPa.

Since the measurement sensitivity is driven by the volume expansion of the fiber, an increase of the change in volume of the fiber upon a change in temperature (i.e., an increase of CTE) at low temperatures (about 4 K to 77 K or lower) leads to an increase in sensitivity of the sensing system. In addition, in order to maximize the strain that is transferred to the fiber core, the Young's modulus of the coating material must be as large as possible (e.g., larger than the E of SiO₂).

It should further be noted that in some embodiments, the coating 309 can be dependent upon how well the coating couples to the fiber, other materials surrounding the fiber (e.g., applications where the fiber is integrated with other materials), the application of the fiber, and/or other factors that may affect the ranges of the CTE and/or the Young's modulus as can be appreciated. In some embodiments, the enhanced optical fiber 300 may comprise an intermediate layer (e.g., nickel (Ni), Tin (Sn), or other metals) between the cladding 306 and the coating 309 to provide a satisfactory bonding strength.

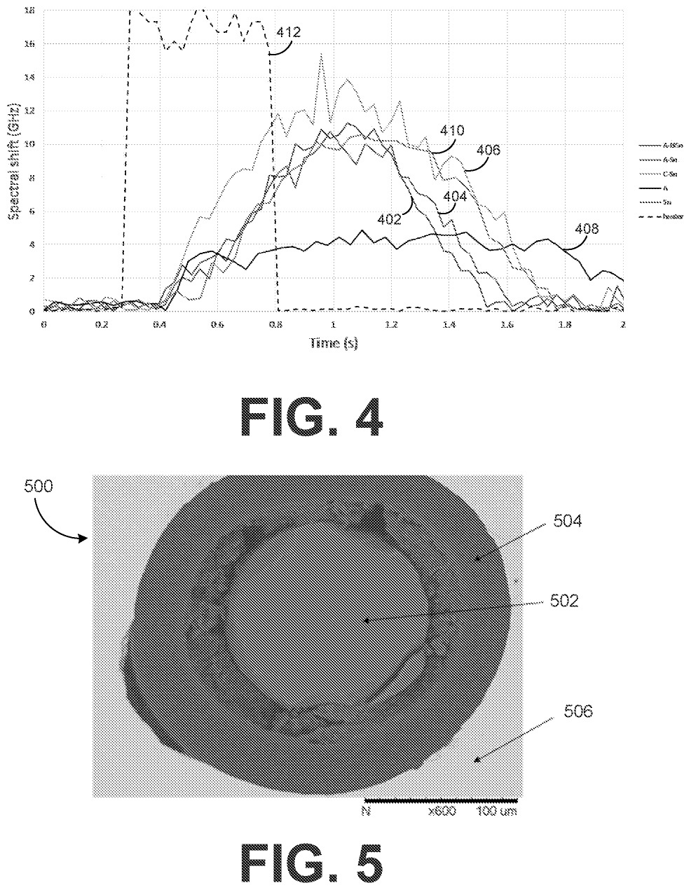

Referring next to FIG. 4, shown is an example of a graphical representation of experimental results on thermal sensitivity of optical fibers 300 with different coating materials, at 4.2 K and interrogated by Rayleigh scattering. The experiment consists of imparting a heat pulse with same energy and same power to the different samples and measuring the spectral shift as a function of time. All the samples are cooled to 4.2 K before starting the measurements. Each fiber sample is surrounded by a heater that is of the exact same shape and properties. Since the imposed thermal perturbation is the same for all the samples, the higher the spectral shift change, the more sensitive the sample is. All the samples whose sensitivities are described by the plots in FIG. 4 comprise a 125 μm silica cladding and one or more coating layers. The letters in the legend correspond to the materials coated on top of the silica cladding. The notation is defined as follows: A 408 stands for acrylate. Sn 410 is tin. A-BiSn 402 is a composite coating of acrylate on silica cladding and Bi—Sn alloy on acrylate. Analogously, A-Sn 404 is a composite coating tin on acrylate (on silica cladding). C—Sn 406 stands for carbon on tin. Therefore, note that A-Sn is not mixture of Acrylate and tin, but a layered composite coating that consists of a pure tin layer on a pure acrylate layer. The dashed line that approximate a square wave is the heat pulse 412.

The results clearly show that at 4.2 K a metal coating (Sn) or a metal-carbon or metal-polymer composite coating is more sensitive than a single acrylate coating. Note that a bare optical fiber (comprising a cladding without any coating) would be the least sensitive of the aforementioned samples, whereas the same coating structure reproduced on a thinner cladding (for example 80 μm instead of the 125 μm shown here) would generate a higher sensitivity.

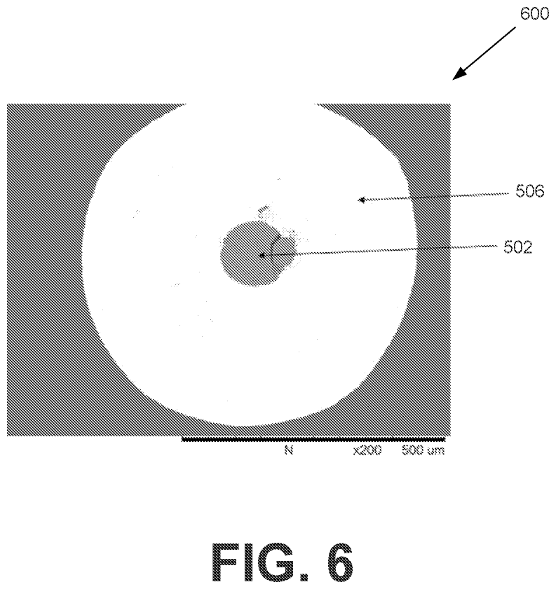

Moving on to FIGS. 5 and 6, shown are example coatings according to various embodiments of the present disclosure. FIG. 5 is an example of a scanning electron microscope (SEM) micrograph of a cross section of a metal-polymer composite coating 500. A 125 μm silica cladding 502 is coated with acrylate 504 and tin 506, wherein the tin 506 is coated atop the acrylate 504 and the acrylate 504 atop the silica cladding 502. FIG. 6 is a cross section of an optical fiber 600 comprising a tin coating 506 deposited on a silica cladding 502, without interlayers.

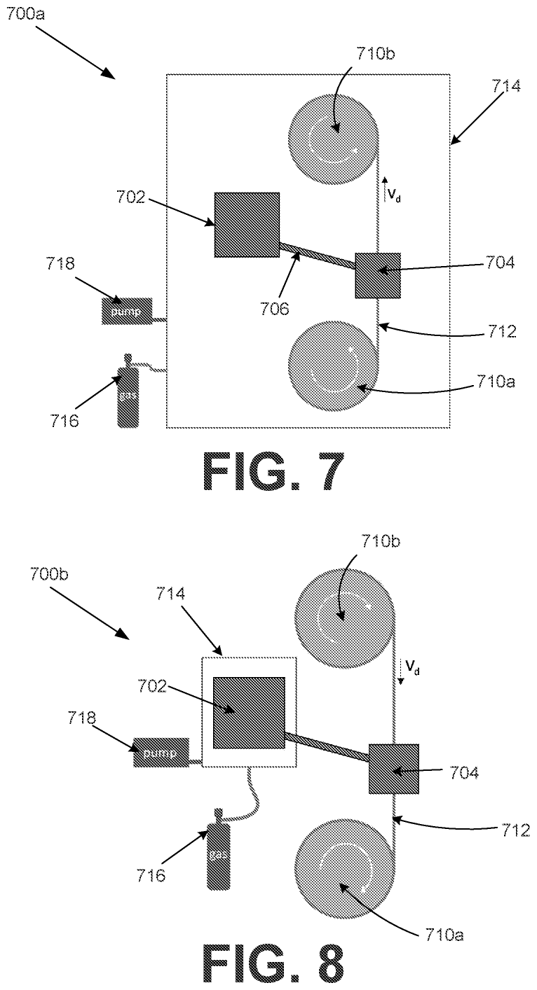

Turning now to FIGS. 7-9, shown are examples of schematic representations of coating systems 700 (e.g., 700a, 700b, 700c) for coating optical fibers with a metallic material 1002 (FIG. 10) according to various embodiments of the present disclosure. According to various embodiments, the metallic material 1002 (e.g., a coating) can be applied to the optical fiber cladding 106 (e.g., usually made of silica or doped silica), a buffer layer that surrounds the cladding 106 and that comprises a polymer (e.g., acrylates, polyimides, etc.), a ceramic layer, and/or a previously deposited metallic layer with higher melting point than the metallic material being deposited on top of it.

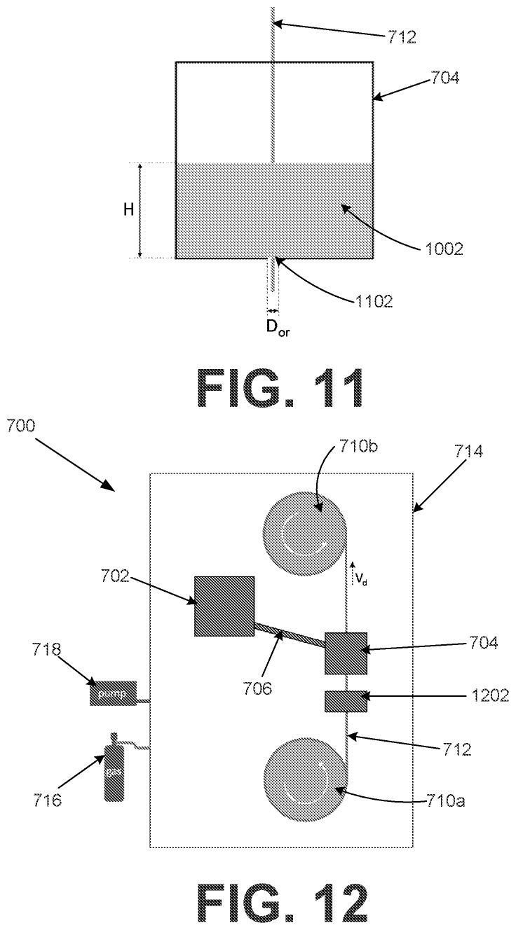

The coating system 700 can comprise a reservoir 702 of the liquid phase of the metallic material 1002 being coated, a coating element 704, a feeding element 706 that delivers the liquid to the coating element 704, at least two spools 710 (e.g., 710a, 710b), and the optical fiber 712. The coating element 704 holds a specific amount of the metallic material 1002 in liquid form that is suitable for depositing the desired coating. The coating element 708 presents an orifice 1102 (FIG. 11) of a diameter (Dₒᵣ ) that depends on the desired coating thickness and on the diameter of the fiber 712 being coated. The diameter (Dₒᵣ) of the orifice 1102 can range between about 50 μm to a few millimeters (e.g., about 4 mm).

The coating system 700 of FIGS. 7-9 further can comprise a chamber 714. The chamber 714 isolates a specific volume from the rest of the laboratory so that the volume isolated by the chamber 714 can either be kept at a lower pressure than about 1 atm (vacuum condition) or a different atmosphere can be created by evacuating the chamber 714 and flowing an inert gas into it. In this second case, when a gas different than air is used, although the pressure inside the chamber 714 is typically about 1 atm or slightly lower, the pressure in general can be anything, even higher than 1 atm. In both cases, the chamber 714 is used to avoid oxidation of the coating material 1002 during the process.

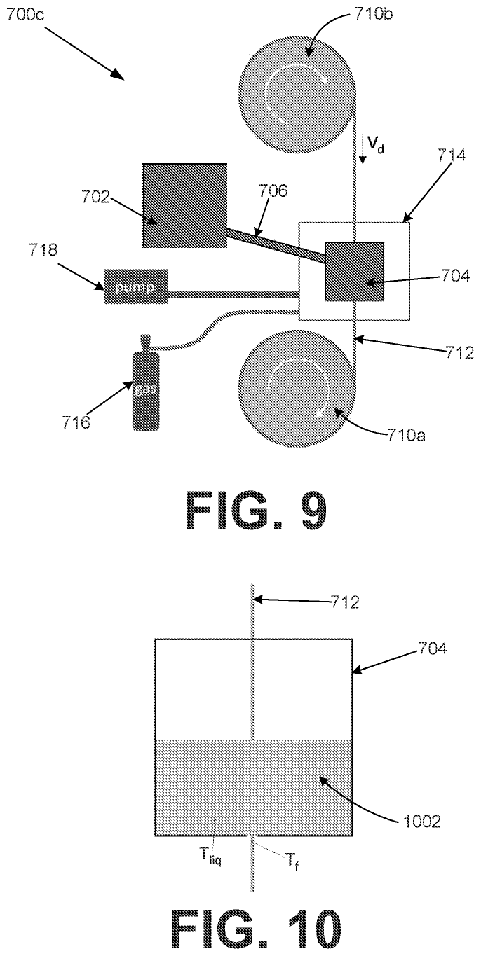

According to various embodiments, the chamber 714 may be connected to a gas 716 and/or a pump 718. In some embodiments, the chamber 714 comprises a vacuum chamber. In other embodiments, the chamber 714 in FIGS. 7-9 comprises a gas chamber containing an inert gas and/or any other gas that is not ambient air. FIG. 7 illustrates the chamber 714 surrounding the entire system (e.g., the reservoir 702, the coating element 704, the feeding element 706, the spools 710, and the optical fiber 712). In FIG. 8, the chamber 714 primarily surrounds only the reservoir 702. In FIG. 9, the chamber 714 primarily surrounds only the coating element 704.

The optical fiber 712 to be coated can be drawn through the orifice 1102 of the coating element 704 with a suitable drawing speed. The drawing speed can range between about 1 cm/s to about 20 m/s. The optical fiber 712 unwinds from the first spool 710a preceding the coating element 704 and rewinds onto the second spool 710b that is downstream relative to the coating element 704. It should be noted that the direction of rotation of the spools 710 is not necessarily the direction shown in FIG. 7. In each of the examples illustrated in FIGS. 7, 8, and 9, the spools 710 can rotate in any direction as can be appreciated. Accordingly, the fiber 712 can be drawn in either direction and can be either vertical or horizontal.

Turning now to FIGS. 10 and 11, shown are examples of schematic representations of the coating element 704 according to various embodiments of the present disclosure. The fiber temperature (T_{f}) of the fiber 712 to be coated right before it contacts the coating material 1002 and the liquid phase temperature (T_{liq}) of the coating material 1002 in the coating element 704 are of crucial importance with respect to the bonding process. FIG. 10 corroborates the definition of such temperatures. Note that the T_{liq} in FIG. 10 does not necessarily coincide with melting temperature of the coating material. In fact, a temperature margin of few degrees Kelvin above the melting point temperature (Tₘ) of the coating material 1002 may be suitable. Temperature margins of about 0 to about 50 K are typical and the optimal temperature margin depends on the fiber temperature (T_{f}), drawing speed (V_{d}) and orifice size (Dₒᵣ). FIG. 11 provides an example schematic representation to aid to the definition of the orifice size and the liquid level in the coating element 704, wherein Dₒᵣ is the diameter of the orifice and H is the liquid level.

An optimal drawing speed exists and depends on the melting point of the coating material 1002, the size of the orifice 1102, the temperature of the liquid and the temperature of the fiber at the point of contact with the coating element. For example, the higher the fiber temperature T_{f} of the fiber 712 (FIG. 10) at the point of contact with the coating material 1002, the higher the optimal drawing speed. The same trend holds for the liquid phase temperature T_{liq} of the liquid phase in the coating element 704 (which needs to be above the melting point temperature Tₘ of the coating material 1002 to be liquid, as can be appreciated). So a temperature margin T_{liq}-Tₘ can be defined and it's always positive. The higher the temperature margin T_{liq}-Tₘ, the higher the optimal drawing speed. The relationship between the liquid level (H) (FIG. 11) and the optimal drawing speed is as follows: the higher the liquid level H, the higher the optimal drawing speed. As an example, for a H of about 0.5-1.5 mm and a temperature margin T_{liq}-Tₘ of about 1-10 K, the optimal drawing speed will range between 10-150 cm/s. A drawing speed that deviates from the optimal value causes an insufficient or poor quality coating, whereas the optimal coating speed ensures the best bonding and coating quality and uniformity. Furthermore, a non-constant drawing speed also causes a non-uniform coating thickness and in general a bad coating quality, as can be appreciated.

One of the key factors to high quality coating is the temperature margins between the melting point temperature Tₘ of the coating material 1002, the fiber temperature T_{f} and the temperature of the liquid T_{liq}. For the coating material 1002 to bond on the fiber surface (as an example, the silica cladding), T_{f} needs to be lower than Tₘ, otherwise the coating material 1002 wouldn't solidify on the fiber surface. Therefore, a phase transformation of solidification needs to occur on the fiber surface and the driving force for the transformation is proportional to what is usually referred to as supercooling, which, in the notation used here, is Tₘ-T_{f}. Since the fiber 712 needs to travel through the liquid coating material 1002 (in the coating element 714), the fiber temperature will progressively increase and therefore, the supercooling decreases, as can be appreciated. Therefore, the driving force for solidification and therefore for the coating process, reduces as the fiber travels through the coating element 704. A way to increase said driving force is to precool the fiber 712 before it enters the coating element 704. Thus, a cooling stage 1202 can be added to system configurations of FIGS. 7-9. FIG. 12 illustrates an example schematic representation of a coating system 700 showing the cooling stage 1202 according to various embodiments of the present disclosure.

The addition of the cooling stage 1202 is shown only for the configuration with a chamber 714 surrounding the whole system, as in FIG. 7, but it holds for all the other cases too. As can be appreciated, the aim of the cooling stage 1202 is to reduce the fiber temperature before it enters the coating element 704, without contaminating the fiber surface. This can be done in multiple ways, including the use of an inert gas (e.g., nitrogen vapor generated by a liquid nitrogen bath) that is colder than the fiber temperature before the cooling stage 704, or exposing the fiber 712 to a colder element with a cylindrical symmetry that is conduction cooled by any conventional refrigerator as can be appreciated.

Another parameter that needs to be controlled in the process is the level of the liquid material in the coating element 704. In fact, the higher the liquid level, the longer the fiber 712 will reside in the liquid coating material 1002 and the higher the fiber temperature will be, which, as explained above, reduces the driving force for solidification. The optimal liquid level depends on the drawing speed, the fiber temperature, the coating material (e.g., melting temperature of the coating material), the orifice size, and the temperature of the liquid (T_{liq}).

The systems and methods of the present disclosure are advantageous over known systems and methods. For example, unlike traditional systems and methods, the coating system 700 and associated methods can be used to recoat existing fibers 712 and/or recoat fiber Bragg gratings (since coatings on top of fiber Bragg gratings can't be applied during the drawing process because the Bragg gratings have not been inscribed yet). In addition, the coating system 700 and associated methods can coat even extremely low melting temperature metals (e.g., [please provide examples]) and the temperatures involved in the process are so low (e.g. [please provide examples]) that fiber Bragg gratings can survive the coating process unaltered. Furthermore, the coating system 700 and methods of the present disclosure can coat any length of fiber 712, unlike traditional systems and methods, for example, sputtering, plasma assisted depositions or laser depositions that can coat only very small regions (on the order of the cm) and require long exposure times. In addition, coatings can be applied to the fibers 712 via the coating system 700 and methods more quickly as compared to traditional coating methods, for example, chemical and/or electrochemical coatings (e.g., kinetics involved in chemical processes are much slower than the kinetics of the physical processes used herein (phase transformation of solidification)). In fact, the coating speed equals the drawing speed (V_{d}) that can be as high as meters per seconds. Therefore, as an example, a low temperature metal can be coated on a 1 km optical fiber in about 8 minutes.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. An enhanced optical fiber for distributed sensing, comprising:
a core;
a cladding surrounding the core, the cladding comprising a glass material; and
a coating surrounding the cladding, wherein at least one of a coefficient of thermal expansion (CTE) of the coating is greater than a CTE of silica or a Young's modulus (E) of the coating is greater than an E of silica.

2. The enhanced optical fiber of claim 1, wherein the enhanced optical fiber is configured to detect at least one of a temperature change or a strain within an operating temperature range of about 1.8 Kelvin (K) to about 77 K.

3. The enhanced optical fiber of claim 2, wherein an operating temperature range is about 1.8 K to about 30 K.

4. The enhanced optical fiber of claim 3, wherein the operating temperature range is about 1.8 K to about 5 K.

5. The enhanced optical fiber of claim 1, wherein the coating comprises one or more layers.

6. The enhanced optical fiber of claim 1, wherein the coating comprises at least one of: polyamide (PA), polyethylene (PE), high density polyethylene (HDPE), Polyvinyl chloride (PVC), chlorinated polyvinyl chloride (CPVC), carbon, acrylates, acrylonitrile butadiene styrene (ABS), an epoxy resin, a metal, or an oxide.

7. The enhanced optical fiber of claim 6, wherein the metal comprises at least one of aluminum, aluminum alloy, copper, copper alloy, silver, silver alloy, gold, gold alloy, zinc, zinc alloy, lead, lead alloy, nickel, nickel alloy, indium, indium alloy, bismuth, bismuth alloy, tin, or tin alloy.

8. The enhanced optical fiber of claim 6, wherein the oxide comprises at least one of titania, alumina, ceria or zirconia.

9. The enhanced optical fiber of claim 1, wherein a diameter of the core is about 4 to about 8 μm.

10. The enhanced optical fiber of claim 1, wherein a diameter of the cladding is about 30 to about 125 μm.

11. The enhanced optical fiber of claim 1, further comprising an intermediate layer situated between the cladding and the coating.

12. The enhanced optical fiber of claim 1, wherein the enhanced optical fiber is interrogated via at least one of Raleigh backscattering or Bragg gratings.

13. The enhanced optical fiber of claim 1, wherein the glass material comprises at least one of silica, fluorite glass, or phosphate glass.

14. A method for enhancing an optical fiber for distributed sensing, the method comprising:
inserting the optical fiber into an orifice at a first end of a coating element, the coating element containing a coating material disposed within, the coating material being in a liquid form, and the coating material comprising at least one: a coefficient of thermal expansion (CTE) that is greater than a CTE of silica or a Young's modulus (E) that is greater than an E of silica; and
moving the optical fiber through the coating material contained within the coating element to a second end of the coating element at a predefined speed, the coating material bonding with an outer surface of the optical fiber as the optical fiber moves from the first end to the second end.

15. The method of claim 14, wherein the predefined speed is based at least in part on at least one of a melting point of the coating material, a size of the orifice, a temperature of the coating material in the liquid form, or a temperature of the fiber upon contact with the coating material.

16. The method of claim 14, wherein a temperature of the fiber is lower than a melting point temperature of the coating material.

17. The method of claim 14, further comprising cooling the optical fiber prior to inserting the optical fiber into the coating mechanism.

18. The method of claim 14, wherein a size of the orifice is based at least in part on a coating thickness and a diameter of the optical fiber being coated.

19. The method of claim 14, further comprising transferring the coating material from a reservoir to the coating element via a feeder element.

20. The method of claim 14, further comprising controlling a liquid level of the coating material within the coating element, the liquid level being based at least in part on at least one of the predefined speed, a temperature of the fiber, a melting point temperature of the coating material, a size of the orifice, or a temperature of the coating material in the liquid form.
